(19) United States
(12) Patent Application Publication
(10) Pub. No.: US 2014/0149449 A1
(43) Pub. Date: May 29, 2014

(54) SYSTEM AND METHOD FOR PROVIDING INSTANT CONTEXTUAL TRANSLATION

(71) Applicant: KIKIN INC., New York, NY (US)

(72) Inventors: Carlos Bhola, New York, NY (US); Gerald Kropitz, New York, NY (US); Brian Rogers, New York, NY (US); Ludovic Cabre, New York, NY (US); Kapil Goel, New York, NY (US)

(73) Assignee: Kikin Inc., New York, NY (US)

(21) Appl. No.: 13/686,601

(22) Filed: Nov. 27, 2012

(51) Int. Cl. G06F 17/30

(52) U.S. Cl. CPC G06F 17/30424
USPC 707/769

(57) ABSTRACT

A method and system for providing highly relevant, contextual answers in response to a selection of text. Text is selected by a user and, along with user parameters and device parameters, transmitted to a server. The server analyzes received text and parameters. During the analysis process the server then associates a specific function with the text and parameters. The server then executes the function, using the text and parameters as input. The result is then presented to the user by overlaying the result with the originally selected text.

### BACKGROUND OF THE DISCLOSURE

The World Wide Web has become a daily resource for many people. As the World Wide Web continues to accumulate more and more data, a user often finds themselves in need of contextually relevant answers to their questions. Searching for these answers requires the user to abandon their current line of work to search the World Wide Web for the answer to their question.

### SUMMARY OF THE DISCLOSURE

The present disclosure provides a system and method to instantly provide users with contextually relevant answers or information. When a user would like to know more information about an entity presented by a device, the user selects the entity and the system then nearly instantly presents an answer based on the contextual information around the selected entity. Generally, this is achieved by analyzing the selection and other contextual information, such as device and user parameters. Based on this contextual information the system determines the type of information the user is seeking The system then generates or gathers the desired information, and overlays the results of the analysis on or with the originally selected entity.

According to one aspect of the disclosure, a system for providing information regarding semantic entities includes a client device comprising and a remote server. The client device further includes a display unit configured to display content comprising a plurality of entities; an input device configured for selecting at least one entity; at least one processor configured to generate a structured query object comprising the at least one selected entity, at least one client device parameter, and at least one user-specific parameter; and a first communication unit configured to transmit the structured query object to a remote server and receive a result from the remote server. The remote server includes a second communication unit configured to receive the structured query object from the client device and transmit the result to the client device; and at least one processor configured to analyze the structured query object using a plurality of rules to associate a specific function with the search query string, and execute the specific function to generate a response.

In some embodiments, the selected entity is at least one of a measurement, a price, a company name, a word, or a time. In some embodiments, the device parameter is selected from a group comprising at least one of a device type, a device location, a device time zone, a device language and a device system of measurement, and the user-specific parameters is selected from a group comprised of past web browsing history, preferred system of measurement, home time zone, preferred currency type and home location.

In some embodiments, the client device is one of one of a computer, a smart-phone, a tablet, or a laptop computer, and the input device is a mouse or a touch screen. In some embodiments, the remote server is further configured to communicate with at least one information database.

According to another aspect of the disclosure, a method for providing information regarding semantic entities included in content displayed by a client device includes receiving, by a client device, an input containing at least one an entity displayed by the device; gathering, by a client device, at least one client device parameter and at least on user-specific parameter; generating, by a server, a structured query object comprising the at least one selected entity, at least one client device parameter, and at least one user-specific parameter; analyzing, by the server, the structured query object to associate a specific function with the search query string; executing, by the server, the function, using the structured query object as input, to generate a response; and displaying, by the client device, the response.

In some embodiments, the method further comprising transmitting, by the device, the generated search query to the server for analysis, and then transmitting the results back to the client device. In some embodiments, the received input is updated before search query is generated. In some embodiments, the at least one client device parameter is selected from a group comprised of device type, device location, device time zone, device language and device system of measurement; and the at least one user-specific parameters is selected from a group comprised of past web browsing history, preferred system of measurement, home time zone, preferred currency and home location.

In some embodiments, the method also includes analyzing, by the server, the structured query object by iteratively searching for less constraining matches to the search query string. In some embodiments, when executing the function the server gathers data from an external database. In some embodiments, the response is contextually relevant based on the at least one user-specific parameter and the at least one client device parameter and the input, and displayed in substantially real time after receiving the input.

In some embodiments, the method includes displaying the result by replacing the selected entity with the result on the client device. In some embodiments, at least one of the font, font size, screen location, font color, and background color of the result is matched to the selected entity. In some embodiments, the result is magnified when displayed.

According to another aspect of the disclosure, a method for providing information regarding semantic entities included in content includes receiving, by a server, a structured query object comprising a selected entity, at least one client device parameter, and at least one user-specific parameter; analyzing, by the server, the structured query object to associate a specific function with the search query string; executing, by the server, the function, using the structured query object as input, to generate a response; and transmitting, by the server, the response to a client device.

In some embodiments, the method also includes requesting, data from a second server, and receiving, the requested data from the second server. In some embodiments, the method also includes analyzing the structured query object by iteratively searching for less constraining matches to the search query string. In some embodiments, the device parameter is at least one of a device type, a device location, a device time zone, a device language and a device system of measurement, and the user-specific parameter is at least one of a past web browsing history, a preferred system of measurement, a home time zone, a preferred currency and a home geographic location.

### BRIEF DESCRIPTION OF THE DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The system and method may be better understood from the following illustrative description with reference to the following drawings in which:

FIG. 1A is a schematic diagram of a system in accordance with an embodiment of the present disclosure;

FIG. 1B is a exploded diagram of the apparatus of FIG. 1A, in accordance with an embodiment of the present disclosure;

FIG. 2 is a schematic diagram of a system transferring information, in accordance with an embodiment of the present invention;

FIGS. 3 and 4 are flow charts of a method for generating and delivering contextually relevant smart answers with a system, as depicted in FIG. 1, in accordance with an embodiment of the present disclosure;

FIG. 5 is a flow chart of an analysis step for associating a function with a search query string, in accordance with an embodiment of the present disclosure;

FIG. 6A is an exemplary view of a screen shot showing a webpage before a contextually relevant smart answer has been displayed, in accordance with an embodiment of the present disclosure; and

FIGS. 6B-D are exemplary views of a screen shot showing a webpage after displaying a contextually relevant smart answer, in accordance with an embodiment of the present disclosure.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

The present system and methods described herein generally relate to a system for displaying contextually relevant smart answers. According to some embodiments, a user selects at least one semantic entity displayed on a device. The device then gathers data including the selected entities, device parameters and user parameters. In some embodiments, the system then analyzes the data, and associates a function with the selected entities. When executed, the function returns a contextually relevant answer, which the device displays to the end user.

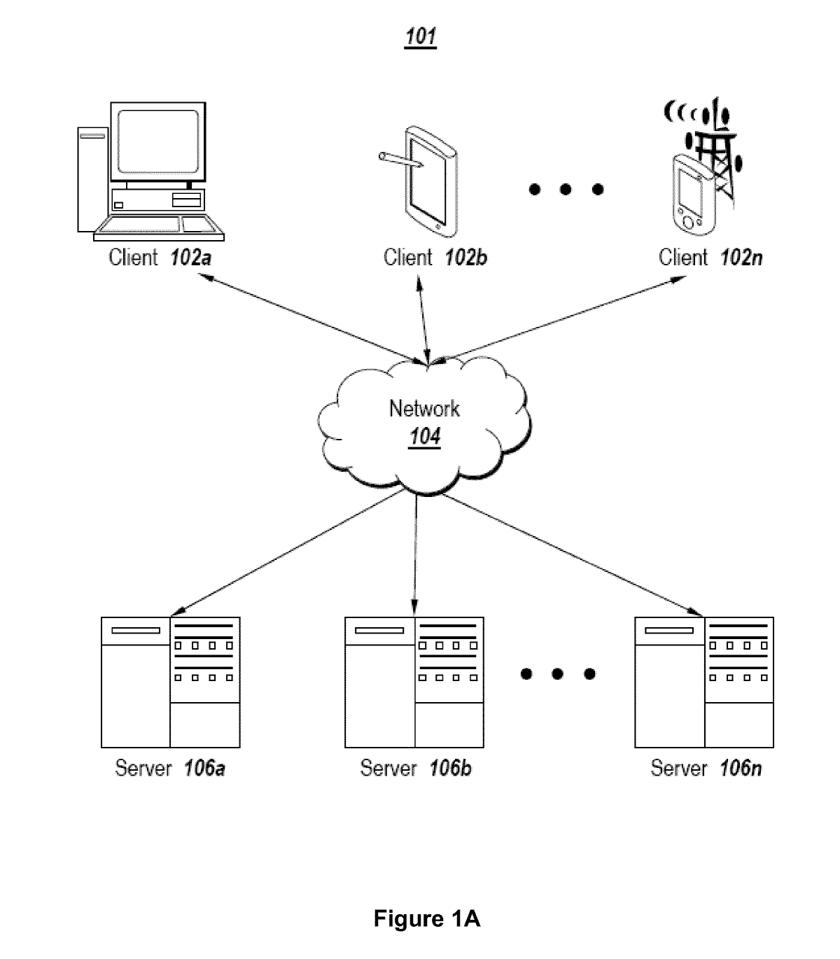

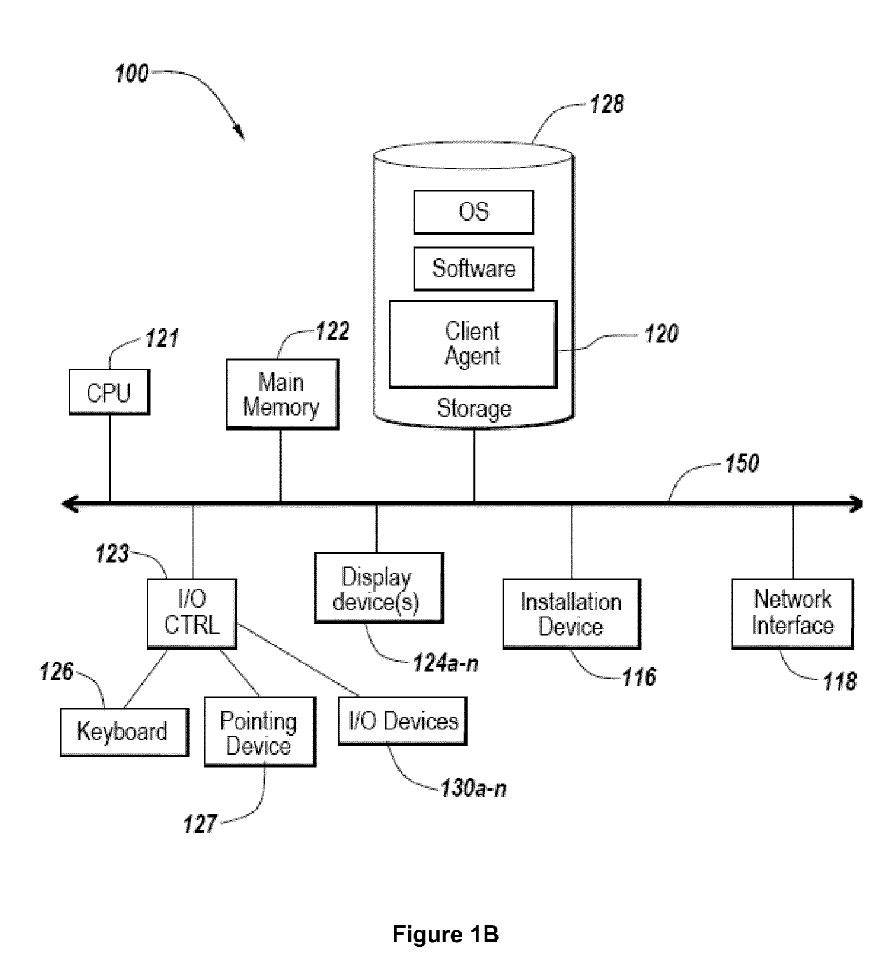

FIG. 1A illustrates a networked environment 101 according to some embodiments, in which an instant answer service is provided. As shown in FIG. 1A, the networked environment 101 includes one or more client machines 102A-102N (generally referred to herein as “client machine(s) 102,” “client(s) 102,” or “client device(s) 102”) in communication with one or more servers 106A-106N (generally referred to herein as “server machine(s) 106,” “server(s) 106,” “remote machine(s) 106,” or “remote server(s) 106”) over a network 104. The client machine(s) 102 can, in some embodiments, be referred to as a single client machine 102 or a group of client machines 102, while server(s) 106 may be referred to as a single server 106 or a single group of servers 106. Although three client machines 102 and three server machines 106 are depicted in FIG. 1A, any number of clients 102 can be in communication with any number of servers 106. In some embodiments, a single client 102 communicates with a plurality of servers 106, while in another embodiment a single server 106 communicates with more than one client machines 102. In yet another embodiment, a single client machine 102 communicates with a single server 106. Further, although a single network 104 is shown connecting client machines 102 to server machines 106, it should be understood that according to some embodiments, multiple, separate networks connect a subset of client machines 102 to a subset of server machines 106.

Client(s) 102 and server(s) 106 may be provided as a computing device 100, a specific embodiment of which is illustrated in FIG. 1B. Included within the computing device 100 is a system bus 150 that communicates with the following components: a central processing unit 121 (“processor”); a main memory 122 providing non-transient storage; storage memory 128 providing non-transient storage; an input/output (I/O) controller 123; display devices 124A-124N; an installation device 116; and a network interface 118. In some embodiments, the storage memory 128 includes: an operating system, software routines, and a client agent 120. The I/O controller 123, in some embodiments, is further connected one or more input devices. Volatile computer memory, non-volatile computer memory, and combinations of volatile and non-volatile computer memory are to be included within the scope of non-transient storage. As shown in FIG. 1B, the I/O controller 123 is connected to a camera 125, a keyboard 126, a pointing device 127 such as, but not limited to, a mouse or touch screen, and a microphone 129.

Various embodiments of the computing machine 100 include a central processing unit 121 characterized by a microprocessor that respond to and process instructions fetched from the main memory unit 122. Still other embodiments of the central processing unit 122 include any one or combination of the following: a microprocessor, a microcontroller, a central processing unit with a single processing core, a central processing unit with two processing cores, or a central processing unit with more than one processing core.

While FIG. 1B illustrates a computing device 100 that includes a single central processing unit 121, in some embodiments the computing device 100 include one or more processing units 121. In these embodiments, the computing device 100 can store and execute firmware or other executable instructions that, when executed, direct the one or more processing units 121 to simultaneously execute instructions or to simultaneously execute instructions on a single piece of data. In other embodiments, the computing device 100 store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 includes one or more processing cores. For example, according to some embodiments the processing unit 121 has two cores, four cores, eight cores, or any number of cores. In some embodiments, the processing unit 121 comprises one or more parallel processing cores. The processing cores of the processing unit 121, in some embodiments, access available memory as a global address space, or in other embodiments, memory within the computing device 100 is segmented and assigned to a particular core within the processing unit 121. In some embodiments, the one or more processing cores or processors in the computing device 100 can each access local memory. In still other embodiments, memory within the computing device 100 is shared amongst one or more processors or processing cores, while other memory can be accessed by particular processors or subsets of processors. In embodiments where the computing device 100 includes more than one processing unit, the multiple processing units are included in a single integrated circuit (IC). These multiple processors, in some embodiments, are linked together by an internal high speed bus, which may be referred to as an element interconnect bus.

The computing device 100, in some embodiments, includes a graphics processor or a graphics processing unit (not shown). In various embodiments, the graphics processing unit includes any combination of software and hardware, and can further input graphics data and graphics instructions, render a graphic from the inputted data and instructions, and output the rendered graphic. In some embodiments, the graphics processing unit is included within the processing unit 121. In other embodiments, the computing device 100 includes one or more processing units 121, such that at least one processing unit 121 is dedicated to processing and rendering graphics.

In various embodiments, the computing machine 100 is embodied in any one of the following computing devices (but is not limited to these devices): a computing workstation; a desktop computer; a laptop or notebook computer; a server; a handheld computer; a mobile telephone; a smartphone; a portable telecommunication device; a media playing device; a gaming system; a mobile computing device; a netbook; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein.

In still other embodiments, the computing device 100 can execute, operate or otherwise provide an application that is any one of the following: software; an application or program; executable instructions; a virtual machine; a hypervisor; a web browser; a web-based client; a client-server application; an ActiveX control; a Java applet; software related to voice over internet protocol (VoIP) communications like a soft IP telephone; an application for streaming video and/or audio or receiving and playing streamed video and/or audio; an application for facilitating real-time-data communications; a HTTP client; a FTP client; or any other set of executable instructions. Still other embodiments include a client device 102 that displays application output generated by an application remotely executing on a server 106 or other remotely located machine. In these embodiments, the client device 102 can display the application output in an application window, a browser, or other output window.

According to various embodiments, the computing device 100 further includes a network interface 118 to interface to a Local Area Network (LAN), Wide Area Network (WAN), the Internet, or any type of network, through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IE

EE 802.11b, IEEE 802.11g, CDMA, GSM, WiMax and direct asynchronous connections). In some embodiments, the network 104 comprises one or more sub-networks, and is installed between any combination of the clients 102, servers 106, computing machines and appliances included within the computing environment 101. In some embodiments, the network 104 is: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. According to some embodiments, the network topology of the network 104 differs within different embodiments, possible network topologies include: a bus network topology; a star network topology; a ring network topology; a repeater-based network topology; or a tiered-star network topology. Additional embodiments include a network 104 of mobile telephone networks that use a protocol to communicate among mobile devices, where the protocol is any one of the following: AMPS; TDMA; CDMA; GSM; GPRS UMTS; or any other protocol able to transmit data among mobile devices.

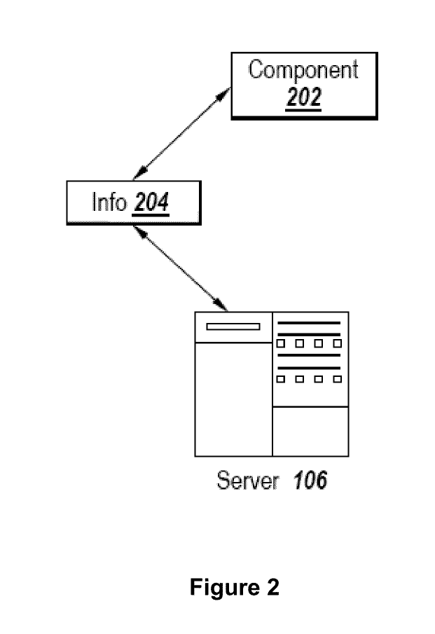

Referring now to FIG. 2, according to various embodiments of the invention, information 204 regarding a selected entity is transferred between the server(s) 106 and the component(s) 202. According to various embodiments, the component(s) 202 is computer software. According to other embodiments, the component(s) 202 is computer hardware or circuitry. According to various embodiments, the component(s) 202 is part of, or executes on, the client(s) 102. According to some embodiments, the component(s) 202 is part of, or executes on, the server(s) 106. According to various embodiments, information 204 is transferred to the server(s) 106 from the component(s) 202. According to various embodiments, information 204 is transferred to the component(s) from the server(s) 106. According to various embodiments, information 204 is transferred back and forth between the server(s) 106 and the component(s) 202.

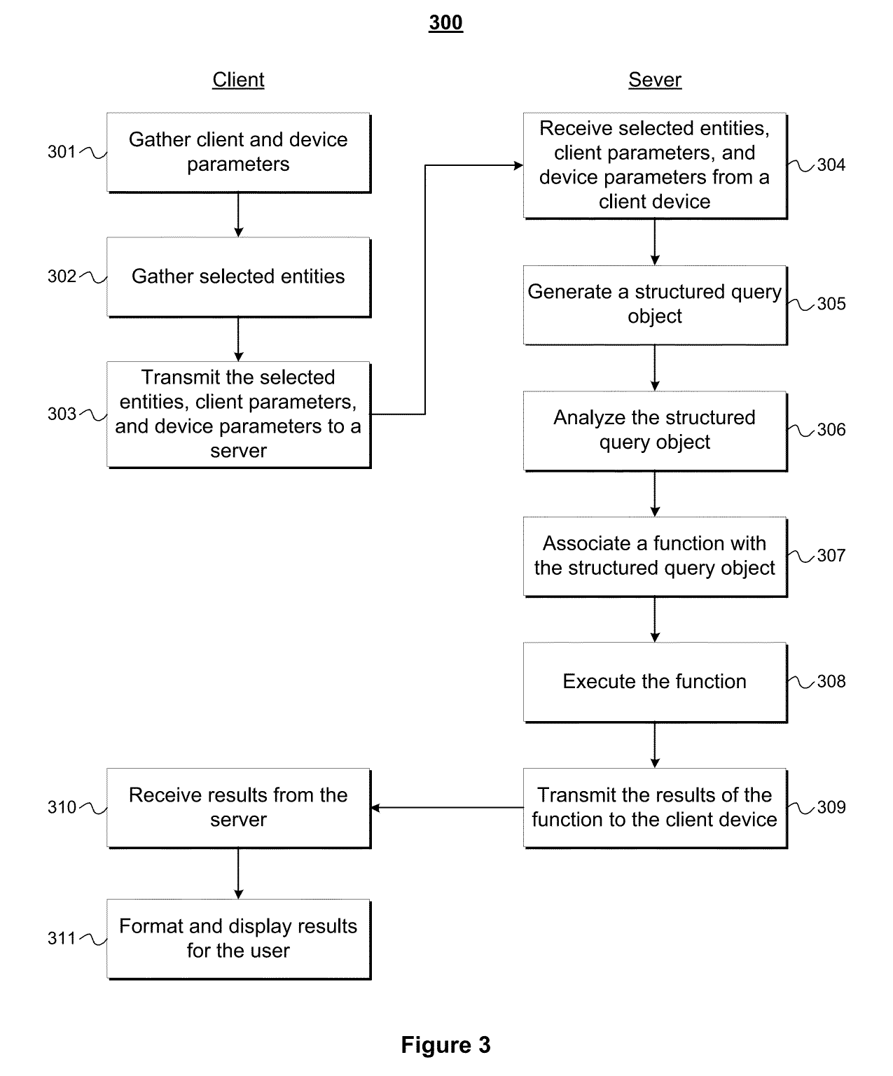

FIG. 3 is a flow chart of a method to generate contextually relevant smart answers in an environment similar to environment 101 described above. The method includes receiving user parameters and client parameters (step 301). Semantic entities are gathered (step 302), and the semantic entities, client parameters, and user parameters are transmitted to a server 106 (step 303). The server 106 receives the selected semantic entities, client parameters, and user parameters (step 304), and generates a structured query object (step 305). The structured query object is then analyzed (step 306). Next, a function is associated with the structured query object (step 307), and the function is executed (step 308). The results of the executed function are transmitted to the client device 102 (step 309). After the client device 102 receives the results (step 310), the results are formatted and displayed to the user (step 311).

As set forth above, the method 300 of generating contextually relevant smart answers begins with receiving client and user parameters (step 301). The client parameters contain information regarding the client device 102. In some embodiments, the client parameters can be, but are not limited to, device type, device configuration, device location, device time zone, device language and device system of measurement. In some embodiments, the user parameters are parameters specific to the user of the device 102. For example, user parameters can be, but are not limited to, past web browsing history, preferred system of measurement, home time zone, preferred currency and home location. In some embodiments, the client parameters and/or the user parameter are intermittently updated. For example, if a user travels from their home in New York City, N.Y. to Paris, France, the device location may update from New York City, N.Y. to Paris, France, while the home time zone may remain New York City, N.Y.

Next, the method 300 continues by gathering selected semantic entities (step 302). The selected entities are selected by an end user on a client device 102. In some embodiments, the user selects the entities with a I/O device 130. For example, a user may use a mouse or a touch sensitive screen to select entities being displayed on the device's display device 124. In some embodiments, the entities within a specific distance from the selected entities are also included in the gathered entities. For example, if a user selects a portion of a sentence, the system 100 may also gather the remaining portion of the sentence for later transmission to the server 102. In some embodiments, the selected embodiments are continually updated as the end user selects or deselects additional entities. For example, a user may visit a webpage displaying the week's forecasted temperatures. The user may then want the temperatures converted from Fahrenheit to Celsius. In initially, the user may only select one day's temperature; however in some embodiments, the user may continue selecting additional day's temperatures—updating the selected entities.

The method 300 of generating contextually relevant smart answers continues, by transmitting the selected entities, client parameters, and device parameters to a server 106 (step 303). In some embodiments, the user parameters, client parameters, and selected entities are transmitted to the server 106 at the same time. In other embodiments, the user parameters, client parameters, and selected entities are transmitted to the server 106 at different times. For example, the user parameters may not update frequently, and may only be sent to the server when initially set or when changed by the user, while the device location parameter may be sent to the server every time the user selects an entity. In some embodiments, the selected entities are continually transmitted to the server as the user makes and updates the selection of selected entities. In other embodiments, the selected entities are sent to the server 106 once the user has stopped selecting entities.

Similarly, as the selected entities, client parameters, and device parameters are transmitted by the client 102, they are received by the server 106 (step 304). After receiving the selected entities, client parameters, and device parameters, the server 106 generates a structured query object (step 305). In some embodiments, the structured query object includes a specific context structure. In some embodiments, the structured query object is compiled as a JSON, XML, or data object. In some embodiments, the structured query object and specific context structure contain the data required for the server 106 to associate a function with the search query string. For example, once the server as received the above mentioned data, it may compare the current device parameters and user parameters. The server may determine the end user has traveled to Paris because the device location parameter and user home location are no longer equal to one another. The server may then add this information to the specific context structure. Accordingly, the structured query object would contain the selected entities, and information regarding the difference in time zones, measurement systems, and location that would result from the user traveling from New York to Paris. In some embodiments, the server extracts the most relevant selected entities and creates the structured query object from those entities. For example, some words may be given addition importance when generating the search query string.

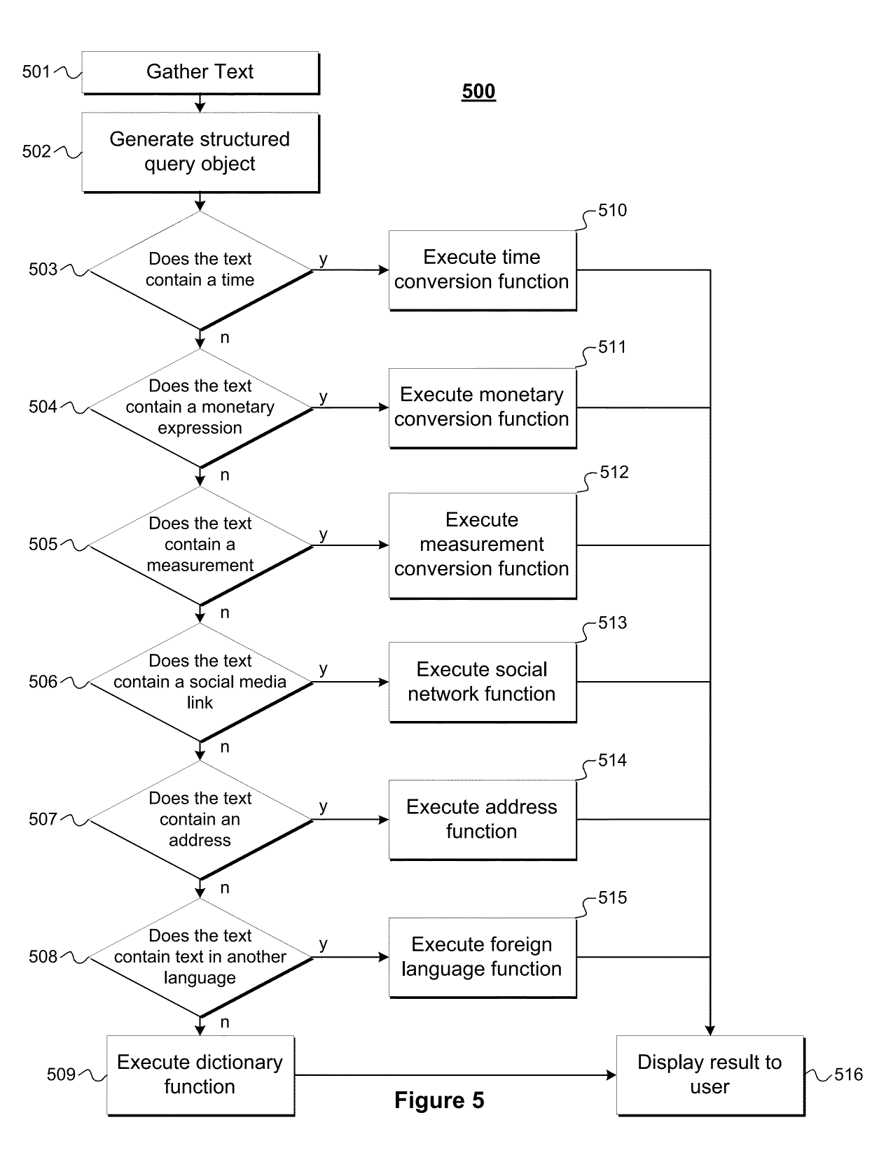

After generating the search query string, the method 300 continues by analyzing the structured query object (step 306). The analysis step is discussed further in relation to FIG. 5, but briefly, the server 106 analyzes the search query by iteratively searching for less constraining matches to the search query string. For example, the server 106 may first search the structured query object to detect the occurrence of time in the selected entities. If the server 106 does not find the time it may search the structured query object for the occurrence of a word. Finding a word the server may then associate a dictionary function with the search query. As non-limiting examples, the server may search the structured query object for times, monetary expressions, units of measurement, social media links, addresses, words, and any combination thereof.

Then, the method 300 continues by associating a function with the analyzed structured query object (step 307). In some embodiments, the function, when executed, generates the smart answer most likely needed by the end user. For example, if the server analyzes a structured query object and determines that it includes the temperature “35° C.,” the server 106 may then associate a temperature conversion function with the search query string. In some embodiments, only one function is associated with the search query string, while in other embodiments a plurality of functions are associated with the search query string.

Next, the method 300 continues by executing the function associated with the structured query object (step 308). In some embodiments, the server uses the structured query object and specific context structure as inputs into the function. Continuing the above example, the server, having associated a temperature conversion function with the structured query object including the selected entities “35° C.”, may then analyze the specific context structure of the structured query object to determine which type of conversion to perform. For example, if the specific context structure indicated the user's preferred scale for temperature is Fahrenheit, the server 106 may convert the Celsius reading into a Fahrenheit reading. However, if the server 106 determines the user's preferred system for temperature is Celsius, the server 106 may convert the temperature into a relative measurement, such as “35° C. is about body temperature.” In some embodiments, when executing the associated function, the server requests additional information for a second server. For example, if the server has detected the selected entity contains a monetary unit different from the user's home monetary unit, the server may access a second server to retrieve the current exchange rate between the two monetary systems.

After calculating the result from the associated function, the server 106 transmits the results to the client device 102 (step 309), which in turn is received by the client device 102 (step 310). In some embodiments, the server returns textual data, a link, and/or an image. For example, if the function's purpose was to covert 17° C. into Fahrenheit, the server may transmit 62.6° F. to the client device.

Once the client device 102 has received the result, it displays the result to the user (step 311). In some embodiments, the client device 102 detects the current font settings and mimics the font, color, and/or layout of the original selected entities. In some embodiments, the returned results may replace the original entities on the display device 124 of the client device 102. In other embodiments, the returned results may be displayed to the user in addition to the originally selected entities. In some embodiments, the non-selected entities on the page are darkened with a layer to improve readability of the selected entities and displayed result. In some embodiments, the returned results are magnified so they are distinctive from the other entities on the screen. In some embodiments, the results remain on the screen until the user navigates away from the current page. In other embodiments, the results remain on the screen until the user ends the selection action.

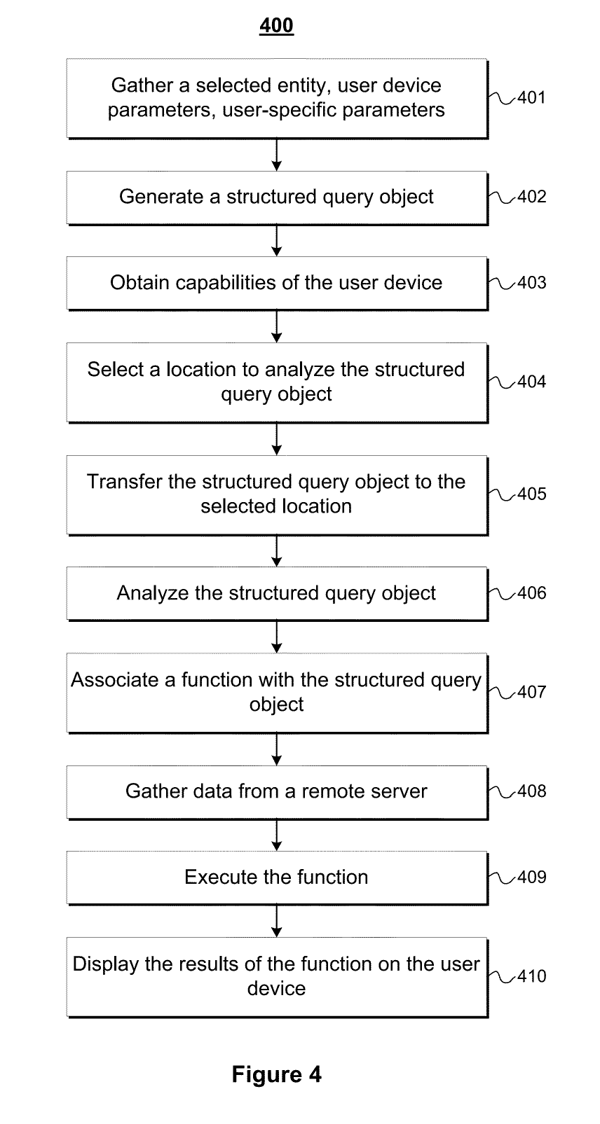

Similar to FIG. 3 above, FIG. 4 is a flow chart of a method to generate contextually relevant smart answers in a environment similar to environment 101 described above. Selected entities, user parameters, and client parameters are gathered (step 401). A structured query object is generated (step 402), and the capabilities of a user device 102 is obtained (step 403). Then a location to analyzed the search query sting is selected (step 404). The structured query object is transferred to the selected location (step 405). Then the structured query object is analyzed at the selected location (step 406), a function is associated with the structured query object (step 407), and then the function is executed (step 409). Finally, the result is displayed on the user device 102 (step 410).

As set forth above, the method 400 contains many of steps described above in relation to method 300. Once the selected entities, user device parameters, and user parameters are gathered, they are used to generate a structured query object as described above. The method continues by obtaining the capabilities of the user device 102 (step 403). As described in relation to system 100, the methods and system described herein can be implemented in a plurality of different embodiments. In some embodiments, the capabilities of the user device 102 make it unfeasible to perform the analysis steps on the user device 102; however, in other embodiments, the user device 102 is fully capable of independently executing the analysis steps. For example, in some embodiments, the system 100 can be a smartphone, while in other embodiments, the system 100 can be a desktop computer. Therefore, in some embodiments, it may be beneficial to perform the analysis locally, while in other embodiments it may be more beneficial to perform the analysis remotely. Accordingly, in some embodiments, the capabilities of the user device are obtained. In some embodiments, the obtained capabilities can include, but are not limited to, processor speed, available memory, storage space available, network speed, and/or network connectivity. In some embodiments, the capabilities of the user device are obtained each time a smart answer is requested. In other embodiments, the capabilities are only obtained once or at periodic intervals.

Then, the method 400 selects a location to analyze the structured query object based on the capabilities of the user device 102. In some embodiments, the user device 102 determines if it possess the capabilities to analyze the search query string. If the user device possesses the capabilities to analyze the search query string, then the user device may select itself as the location to perform the analysis step. However, in other implementations, the user device selects a remote device for the location to analyze the search query string. In some embodiments, more than one location is selected to analyze the search query string. For example, a first portion of the structured query object may be analyzed on the user device 102 and a second portion may be analyzed on a remote server 106. In some embodiments, the determination of where to analyze the structured query object is made for each smart answer request. In other embodiments, the determination is made only as often as the user device capabilities are updated. The method 400 continues by transferring the structured query object to the selected location (step 405), and then the method concludes as described above in relation to method 300.

The skilled artisan will understand that, although the functions are shown in a particular order, they can be done in any order, or certain steps may be skipped entirely.

FIG. 5 is a flow chart of an non-limiting, exemplary analysis step 500 as described in method 300 and method 400 above. Generally, in some embodiments, the analysis step 500 proceeds by searching the structured query object for a match to the most specific function, and then iteratively proceeds to search the structured query object for a match to a less specific function. In some embodiments, the system 100 stops analyzing the structured query object once a first match is detected.

For example, in exemplary step 500, the system 100 first searches to determine if the structured query object contains a reference to a time (step 503). In some embodiments, the system 100 uses regular expressions, or another such matching algorithm to determine if a match occurs. In some embodiments, the system 100 also searches for time zone information associated with the detected time. If the system 100 does not find an associated time zone with the detected time, it may associate the current device time zone with the detected time. In some embodiments, if the systems detects a time within the selected entities, it associates and executes a time conversion function. For example, in the time conversion function, the time zone of the selected entities may be compared to the current time zone of the device. If the two time zones do not match then the time conversion function will convert the selected time entity into the time zone preferred by the user.

Similar to step 503 above, the system 100 may also analyze the structured query object for monetary values (step 504) and specific measurements (step 505). In some embodiments, the system 100 again uses regular expressions, or other such matching algorithms to determine which function to match to the search query string. As described above, in some embodiments, the system 100 retrieves additional information form a remote device. For example, when the system determines the selected entities contain a monetary value not in the user's preferred monetary system, the system may request the latest exchange rate from a remote server. In some embodiments, the system requests such external data each time a function requiring the data is executed, and in other embodiments the system requests the external data at specific intervals. For example, exchange rates may be gathered daily while stock prices are refreshed every thirty minutes. As described briefly above, in some embodiments the function returns a relative result. For example, if the system 100 has determined the selected entities contains the measurement “1 kg,” the system may return “1 kg=2.2 lbs,” or it could return a relative answer such as “1 kg is about 3 full soda cans.” In some embodiments, the system returns both a relative and an exact conversion. In other embodiments, the system returns a relative result only if the selected measurement is already in the users preferred system of measurement.

In some exemplary embodiments, the step 500 includes searching for a social media link in the selected entities (step 505). For example, the system may analyze the selected text to determine if it contains a twitter, or similar, handle; an email address; a Facebook link; or other such social media link. As a non-limiting exemplary embodiment, if the system 100 detects a twitter handle, it may execute a function that displays the latest tweets associated with the handle, shows the user profile of the associated handle, and/or indicates if the device user is following or being followed by the user of the associated handle.

Additionally, in some exemplary embodiments, the step 500 includes searching for an address (step 507). In some embodiments, the system uses regular expressions and/or a heuristic algorithm to detect address. In some embodiments, after detecting an address, the system associates a function that displays a map, provides directions to the detected address, and/or provides the weather at the detected address.

In some embodiments, step 500 continues to search the structured query object for text in a foreign language (step 508). For example, in some embodiments, the system uses a Bayesian filter to determine if the selected word is in a language other than the user's preferred language. If the system 100 determines the word is in a language other than the user's preferred language, it may associate a function to translate the word into the user's preferred language.

In some embodiments, the most general analysis associates a dictionary function with the selected text. In some embodiments, the system 100 automatically associates the dictionary function with the selected entities if no match is found to another function. In some embodiments, the system 100 only associates the dictionary function with the selected words if the system 100 determines the selected words most likely fall beyond the user's normal language proficiency. In some embodiments, the user's language proficiency is determined by monitoring the number of misspellings they make. In some embodiments, an uncommonness score is given to the words of a language. The uncommonness score is directly related to the probability of the word occurring in the given language. In some embodiments, the uncommonness score and/or the user's language proficiency is used to determine if the dictionary function should be associated with the search query string.

The above mentioned analysis steps are provided as a non-limiting example. In some embodiments, the system may analyze the structured query object for additional features. For example, the system may analyze the structured query object for company names and then associate a function with them that displays the current stock price or contact information. Additionally, the system may analyze the structured query object for restaurant or movie names, and provide reviews, seating availability, or show times. In some embodiments, the selected entity is a picture, and the system associates a function that attempts to identify or classify the image. For example, if the user selected an image of an iconic place, the system may associate a function that performs image analysis on the image and returns to the user that picture is an image of the Golden Gate Bridge.

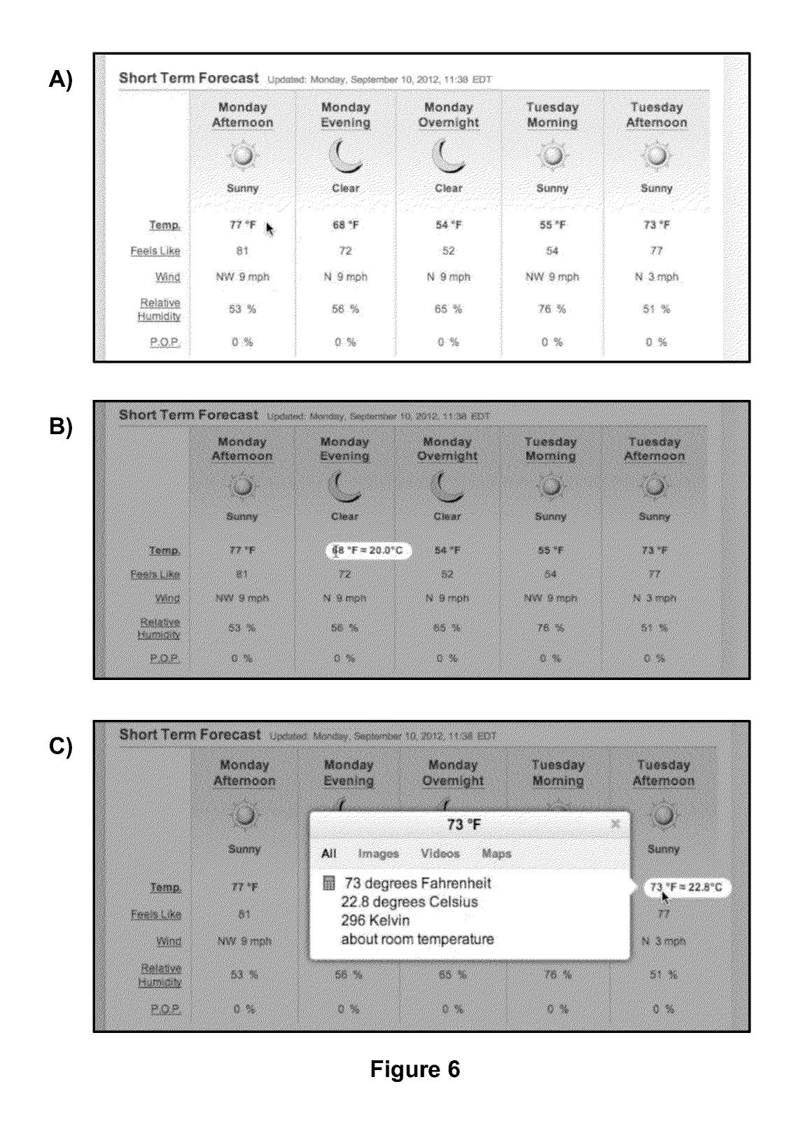

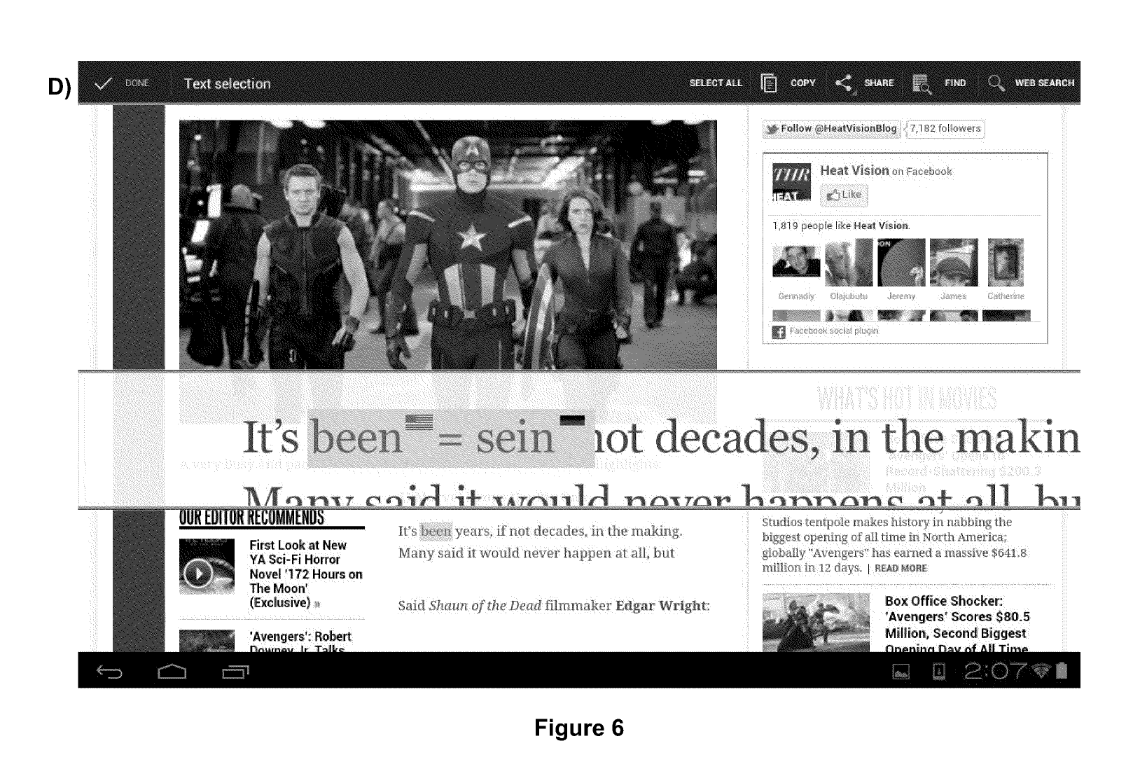

FIGS. 6A-D illustrate the user experience of the smart answers service according to a non-limiting, exemplary embodiment. In FIG. 6A, the user has navigated to a webpage in a web browser. In this example, the webpage includes a weekly forecast, the forecast further includes a plurality of temperatures in Fahrenheit. In FIG. 6B, the user has activated the smart answers service by selecting 68° F. In this embodiment, the service almost instantly overlays “=20° C.” on the webpage. In some embodiments, the service replicates the font and style of the text in the webpage, and displayed the overlay answer in a similar font and style. In some embodiments, the overlay answer would not supplement the original text, but rather replace it in the webpage. For example “20° C.” would replace “68° F.,” and the webpage would appear as if 20° C. was the original text of the page.

In the exemplary embodiments of FIG. 6B, an additional darkening overlay is overlaid over the majority of the webpage to highlight the selected text and/or answer. In some embodiments, the user may continue to select entities, and the system 100 will continually provide updated answers based on the selected text.

FIG. 6C illustrates an embodiment with an expanded answer function. In some embodiments, the expanded answer is provided automatically to the user. In other embodiments, the expanded answer is only provided to the user if he hovers over the selected entity for a specified amount of time or if when selecting the entities also holds down a modifier key. For example, if the user holds down the “shift” key while selecting the entities, the system may also return the expanded answer. In some embodiments, the expanded answer provides additional information about the selected entities. For example, the expanded answer in FIG. 6C provides the temperature in additional, less standard, units of measurement. The example also illustrates the relative measurements discussed above. In the example of FIG. 6C, the system informs the user that 73° F. is about room temperature. Additionally, as show in the exemplary embodiment of FIG. 6C, the expanded answer may include additional tabs, providing further informational about the selected entity.

FIG. 6D illustrates an exemplary embodiment of a smart answer. In the embodiment illustrated in FIG. 6D, a user selected the word “been.” In this embodiment, the system 100 determined that “been” is an English word. Based on the user parameters, the system 100 determined the user's preferred language to be German. Next, during the analysis steps described above, the system 100 associated and executed a language translation function. In the exemplary embodiment of FIG. 6D, the system 100 magnified and overlaid the result of the executed function. Additionally, the system included country flags with the words to indicate the language of each word to the user. In some embodiments, the system replaces the selected entity with the translation of the entity when overlaying the result.

Having now described some illustrative implementations and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one embodiment are not intended to be excluded from a similar role in other implementations or embodiments.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any implementation disclosed herein may be combined with any other implementation or embodiment, and references to “an implementation,” “some implementations,” “an alternate implementation,” “various implementation,” “one implementation” or the like are not necessarily mutually exclusive and are intended to indicate that a particular feature, structure, or characteristic described in connection with the embodiment may be included in at least one implementation or embodiment. Such terms as used herein are not necessarily all referring to the same embodiment. Any embodiment may be combined with any other embodiment, inclusively or exclusively, in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed:

1. A system for providing information regarding semantic entities, the system comprising:
a client device comprising:
a display unit configured to display content comprising a plurality of entities;
an input device configured for selecting at least one entity;
at least one processor configured to generate a structured query object comprising the at least one selected entity, at least one client device parameter, and at least one user-specific parameter; and
a first communication unit configured to transmit the structured query object to a remote server and receive a result from the remote server; and
the remote server comprising:
a second communication unit configured to receive the structured query object from the client device and transmit the result to the client device; and
at least one processor configured to analyze the structured query object using a plurality of rules to associate a specific function with the search query string, and execute the specific function to generate a response.

2. The system of claim 1, wherein the selected entity is at least one of a measurement, a price, a company name, a word, or a time.

3. The system of claim 1, wherein the at least one client device parameter is selected from a group comprised of a device type, a device location, a device time zone, a device language and a device system of measurement.

4. The system of claim 1, wherein the at least one user-specific parameters is selected from a group comprised of past web browsing history, preferred system of measurement, home time zone, preferred currency type and home location.

5. The system of claim 1, wherein the client device is one of one of a computer, a smart-phone, a tablet, or a laptop computer.

6. The system of claim 1, wherein the input device is one of a mouse or a touch screen.

7. The system of claim 1, wherein the first and second communication units are configured to communicator over a network.

8. The system of claim 1, wherein the remote server is further configured to communicate with at least one information database.

9. A method for providing information regarding semantic entities included in content displayed by a client device, the method comprising:
receiving, by a client device, an input containing at least one an entity displayed by the device;
gathering, by a client device, at least one client device parameter and at least on user-specific parameter;
generating, by a server, a structured query object comprising the at least one selected entity, at least one client device parameter, and at least one user-specific parameter;
analyzing, by the server, the structured query object to associate a specific function with the search query string;
executing, by the server, the function, using the structured query object as input, to generate a response; and
displaying, by the client device, the response.

10. The method on claim 9, further comprising transmitting, by the device, the generated search query to the server for analysis.

11. The method of claim 10, further comprising transmitting, by the server, the response to the client device.

12. The method of claim 9, wherein the received input is updated before generating a search query.

13. The method of claim 9, wherein the at least one client device parameter is selected from a group comprised of device type, device location, device time zone, device language and device system of measurement.

14. The method of claim 9, wherein the at least one user-specific parameters is selected from a group comprised of past web browsing history, preferred system of measurement, home time zone, preferred currency and home location.

15. The method of claim 9, further comprising analyzing, by the server, the structured query object by iteratively searching for less constraining matches to the search query string.

16. The method of claim 9, wherein executing, by the server, the function further comprises gathering data from an external database.

17. The method of claim 9, wherein the response is contextually relevant based on the at least one user-specific parameter and the at least one client device parameter and the input.

18. The method of claim 9, further comprising displaying the result in substantially real time after receiving the input.

19. The method of claim 9, further comprising displaying, by the device, the result by replacing the selected entity with the result on the client device.

20. The method of claim 9, further comprising matching, by the device, at least one of the font, font size, screen location, font color, and background color of the result to the selected entity.

21. The method of claim 9, further comprising displaying, by the device, the result in addition to the selected entity displayed by the device.

22. The method of claim 9, further comprising magnifying, by the device, the result in relation to the entities displayed by the device.

23. A method for providing information regarding semantic entities included in content displayed by a client device, the method comprising:
receiving, by a server, a structured query object comprising a selected entity, at least one client device parameter, and at least one user-specific parameter;
analyzing, by the server, the structured query object to associate a specific function with the search query string;
executing, by the server, the function, using the structured query object as input, to generate a response; and
transmitting, by the server, the response to a client device.

24. The method of claim 23, further comprising:
requesting, by the server, data from a second server; and
receiving, by the server, the requested data from the second server.

25. The method of claim 23, further comprising analyzing, by the server, the structured query object by iteratively searching for less constraining matches to the search query string.

26. The method of claim 23, wherein the device parameter is at least one of a device type, a device location, a device time zone, a device language and a device system of measurement.

27. The method of claim 23, wherein the user-specific parameter is at least one of a past web browsing history, a preferred system of measurement, a home time zone, a preferred currency and a home geographic location.
